(19) United States
(12) Patent Application Publication
(10) Pub. No.: US 2017/0127740 A1
(43) Pub. Date: May 11, 2017

(54) Antimicrobial Arm Sleeve

(71) Applicant: The Sneeve LLC, Port Washington, NY (US)

(72) Inventor: Stan Bratskeir, Sands Point, NY (US)

(73) Assignee: The Sneeve LLC, Port Washington, NY (US)

(21) Appl. No.: 15/027,509

(22) PCT Filed: Apr. 5, 2016
(86) PCT No.: PCT/US2016/025972

§ 371 Date: Apr. 6, 2016

Related U.S. Application Data
(60) Provisional application No. 62/144,668, filed on Apr. 8, 2015.

(51) Int. Cl. A41D 27/12; A01N 25/34; A01N 37/04; A01N 25/08; A41B 15/00; A01N 59/16

(52) U.S. Cl. CPC A41D 27/12; A41B 15/00; A01N 59/16; A01N 37/04; A01N 25/08; A01N 25/34; A41D 2400/34; A41D 2400/52

(57) ABSTRACT

A sleeve is provided with an antibacterial substance to substantially prevent germs from surviving thereon. The sleeve is designed to be worn by children over their existing clothes, worn over the elbow so that the wearer may cough or sneeze into it with the antibacterial substance acting to eliminate any germs transferred from the wearer to the sleeve by that cough or sneeze. The sleeve is elastic and held in place by a frictional fit that allows for easy application and removal without limiting range of motion for the user.

### CROSS-REFERENCE TO RELATED APPLICATIONS

This application is a national stage filing of International Application No. PCT/US2016/025972, filed Apr. 5, 2016, which claims the benefit of U.S. Provisional No. 62/144,668, filed Apr. 8, 2015, each of the above being incorporated herein by reference in its entirety.

### BACKGROUND

The Centers for Disease Control and Prevention (hereinafter “CDC”) provide a series of guidelines specifically aimed to curb the transmission of illness through sneezing and coughing. While standard etiquette dictates that a sneezing or coughing individual cover his or her mouth with their hand while doing so, preventing germs from becoming airborne, the germs may still attach and survive on the hands. Contact transmission from that individual's hand thus becomes an issue.

Because an individual's hand has limited usefulness in preventing disease transmission, the CDC suggests covering the mouth and nose with a tissue instead of the hand, and then placing the tissue into the garbage. In situations where tissues are not available, the CDC suggests that the individual sneeze or cough into the upper sleeve of a garment they are wearing.

Compliance with these guidelines is relatively simple for independent, health-conscious adults. However, compliance amongst children is a greater challenge. Children typically contract between 7-10 colds per year, each cold lasting about 7-10 days. Sick young children are far less likely to consistently carry tissues to cover their nose and mouth upon the occurrence of a sneeze or cough. Therefore, it can be highly useful to teach children to cough or sneeze into their upper arms as recommended by the CDC.

Once a child has coughed or sneezed into the upper arm, however, the risk of disease transmission has not been completely eliminated. Germs remain viable on the clothing for some time. Further, children are less likely to be mindful that their illness may be communicable to other individuals, and are more likely to come into contact with adults or other children than a similarly ill adult.

What is desired, therefore, is an additional layer of protection that prevents further spread of germs from children who have been taught to sneeze and/or cough into their garments.

### SUMMARY

In some embodiments, the present disclosure is directed to an antimicrobial barrier, wearable by an individual, comprising an interior surface providing a frictional fit with an individual, an exterior surface having an antimicrobial substance disposed thereon and wherein the exterior surface is held substantially stationary relative to an anatomical feature of the individual through the frictional fit. In some embodiments, the barrier is elastic to provide a radially compressive force. In some embodiments, the barrier is flexible to maintain substantially full range of motion for a joint of the individual. In some embodiments, the anatomical feature is selected from the group comprising: a joint, area adjacent to the joint, and combinations thereof. In some embodiments, the barrier is cylindrical. The barrier is composed of a hydrophilic fabric. In some embodiments, the barrier is non-woven.

In some embodiments, the barrier comprises a first end and a second end, the first end releasably attached to the second end to provide the frictional fit when attached. In some embodiments, the first and second end are heat welded to hold the component in a cylindrical conformation. In some embodiments, the antimicrobial substance is selected from the group consisting of: citric acid, silver, and combinations thereof. In some embodiments, the antimicrobial substance is disposed on a surface between the exterior surface and the interior surface. In the embodiments, the antimicrobial substance is disposed on the interior surface. In some embodiments, the antimicrobial substance comprises at least 0.001% by weight silver. In some embodiments, the antimicrobial substance comprises at least 4% by weight citric acid. In some embodiments, the antimicrobial substance comprises 0.002-0.004% by weight silver. In some embodiments, the antimicrobial substance comprises 4% to 5% by weight citric acid.

In some embodiments, the barrier is in the shape of a tube. In some embodiments, the barrier is sewn to form the tube shape.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1A is an antibacterial arm sleeve consistent with some embodiments of the instant disclosure, portrayed in a collapsed conformation.

FIG. 1B shows the antibacterial arm sleeve according FIG. 1A, portrayed in an expanded conformation.

FIG. 2 shows the antibacterial arm sleeve according FIG. 1A worn by a user.

FIG. 3 shows an additional view of the antibacterial arm sleeve according to FIG. 1A worn by a user.

FIG. 4 shows the antibacterial arm sleeve according to FIG. 1A prior to the joining of a first end to a second end.

FIG. 5 shows the antibacterial arm sleeve according to FIG. 1A, wherein a small area of the sleeve is magnified to show inclusion of an antibacterial substance thereon.

### DETAILED DESCRIPTION

In some embodiments, the present disclosure is directed to a sleeve designed to be worn by a user to provide an antibacterial effect. In some embodiments, the sleeve is removable. In some embodiments, the sleeve is designed to be worn on an appendage of user, such as an arm. In some embodiments, the sleeve is separate from, and supplemental to, other garments worn by the user, such as shirt, sweatshirts, dresses, and the like, which may themselves have sleeves. In some embodiments, the sleeve according to one embodiment of the present disclosure is integrated into the sleeve of another garment worn by the user.

The sleeve is particularly useful for increasing compliance with CDC guidelines for coughing and sneezing by children. The sleeve provides an antibacterial layer to a user that kills up to 99.9% of germs that come into contact with it. Thus, children wearing the invention of the instant disclosure on their arms are provided with an area onto which they can easily sneeze or cough, so long as the invention is brought into proximity with the mouth when doing so. Fluids and germs emitted from the user during the cough or sneeze are thus deposited on the sleeve, where an antibacterial substance limits the spread of viable bacteria therefrom. In some embodiments, the sleeve is disposable. In some embodiments, the sleeve is washable and reusable. In some embodiments, the sleeve includes special designs or graphics in an effort to increase fun factor and increase compliance for child users.

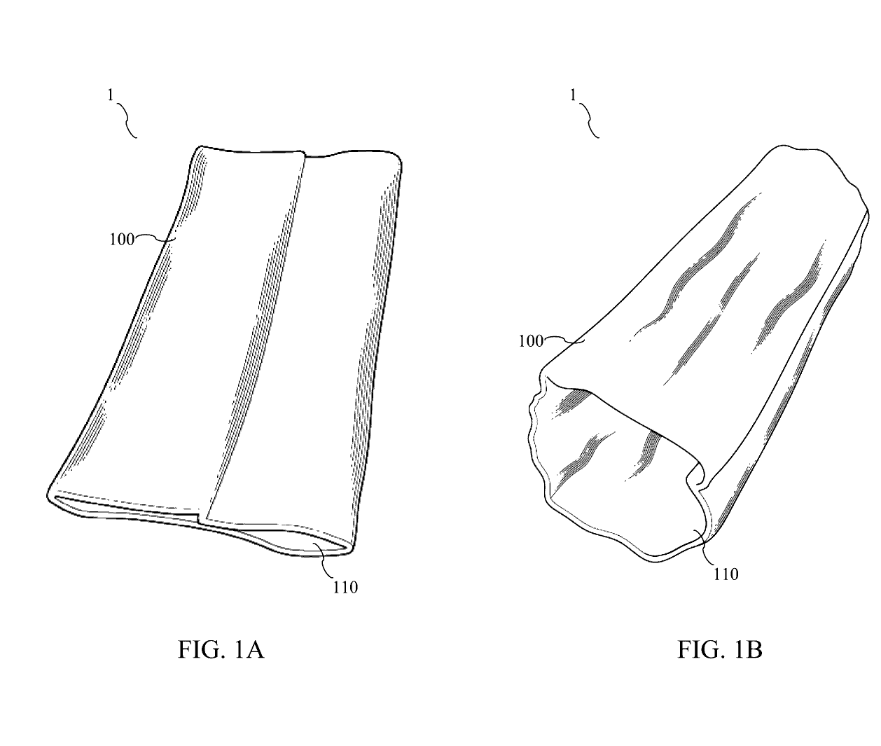

Referring to FIGS. 1A and 1B, in some embodiments the sleeve of the instant disclosure comprises a barrier 1. In some embodiments, barrier 1 is composed at least in part from fabric. In some embodiments, the fabric is non-woven. In some embodiments, the fabric is a non-woven textile. One supplier of such fabric is Kimberly-Clark. In some embodiments, barrier 1 is hydrophilic. In some embodiments, barrier 1 is elastic, the utility of which will be discussed in greater detail below. In some embodiments, material composing barrier 1 is itself elastic. In some embodiments, a separate elastic material is provided to impart elasticity to barrier 1. In some embodiments, some areas of barrier 1 are elastic while other areas of barrier 1 remain substantially inelastic. In some embodiments, the fabric stretches in one direction to accommodate a range of arm sizes. In some embodiments, the one direction is the width.

In some embodiments, barrier 1 is designed to be worn around an appendage of a user. In some embodiments, the user is a child. In some embodiments, the user is an adult. In some embodiments, barrier 1 includes an exterior surface 100 and an interior surface 110. In some embodiments, interior surface 110 provides a frictional fit with a user to hold exterior surface 100 substantially stationary relative to the user. In some embodiments, the frictional fit holds exterior surface 100 substantially stationary relative to an anatomical feature of the user. In some embodiments, the term “substantially stationary relative to an anatomical feature” indicates that barrier 1 is held in place on an individual and may move incrementally on that individual when in use, but would require more than the force of gravity to completely remove and also resist large sliding movements that would require a user to constant readjust barrier 1 to be in the desired position. In some embodiments, the frictional fit is provided between interior surface 110 and the user. In some embodiments, the frictional fit is provided between interior surface 110 and a garment worn by the user.

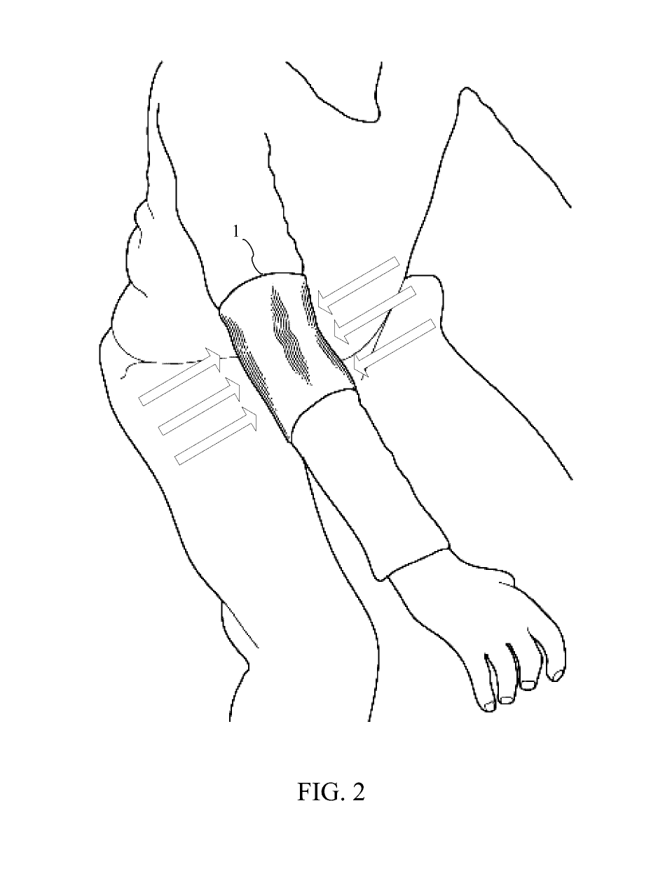

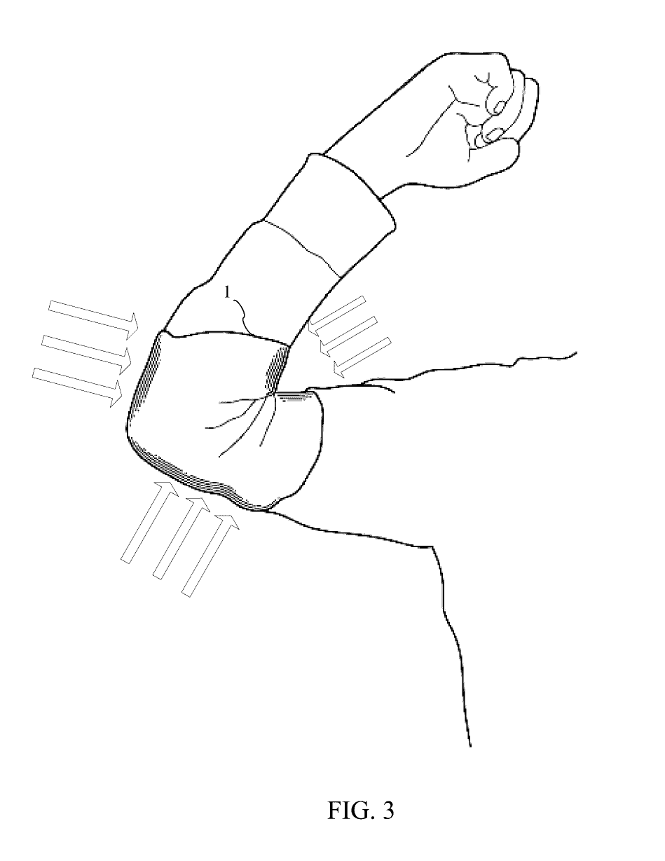

Referring to FIG. 2 and FIG. 3, in some embodiments the frictional fit is provided by a radially compressive force. In these figures, arrows are employed to illustrate the directionality of forces imparted upon a user via barrier 1. In some embodiments, the radially compressive force is the result of the elasticity of barrier 1. In some embodiments, the radially compressive force is the result of tightly wrapping barrier 1 around an appendage of a user (not shown). In some embodiments, such as that shown in FIG. 1A and 1B, barrier 1 is a cylinder or tube. In one embodiment, barrier 1 comes ready-to-wear, as a cylinder. In some embodiments, barrier 1 sewn into a tube shape prior to sale. In some embodiments, barrier 1 is any suitable shape so long as the radially compressive force is still applied to the user and results in the frictional fit described above. In some embodiments, barrier 1 includes an absorbent material. In some embodiments, the absorbent material is included at a sneeze or cough catching section of barrier 1.

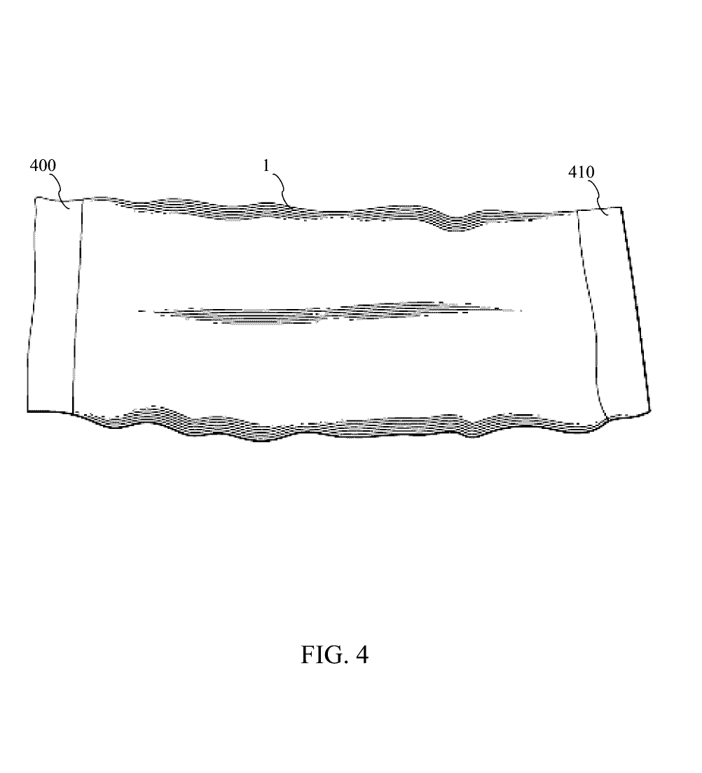

Referring to FIG. 4, in some embodiments, barrier 1 includes a first end 400 and a second end 410 to releasably attach barrier 1 to a user. In some embodiments, first end 400 and second end 410 are permanently attached to form barrier 1. In some embodiments, first end 400 and second end 410 are releasably attached so that a user may apply and remove barrier 1 by attaching and subsequently detaching these ends from each other, encircling an area of their anatomy in the process. In some embodiments, first end 400 and second end 410 are permanently attached. In some embodiments, first end 400 and second end 410 are attached via heat welding. In some embodiments, first end 400 and second end 410 are attached via adhesive. In some embodiments, first end 400 and second end 410 are attached via fasteners. In some embodiments, the fasteners are hook and loop fasteners, such as Velcro.

In some embodiments, the anatomical feature is an appendage, such as an arm. In some embodiments, the anatomical feature is a joint. In some embodiments, the anatomical feature is an area surrounding a joint. In some embodiments, the anatomical feature is an elbow. In some embodiments, a plurality of anatomical features engage in a frictional fit with barrier 1 while in use by a user. Referring again to FIG. 3, in some embodiments, barrier 1 is flexible to allow substantially full range of motion to a joint even when barrier 1 is in use by the user.

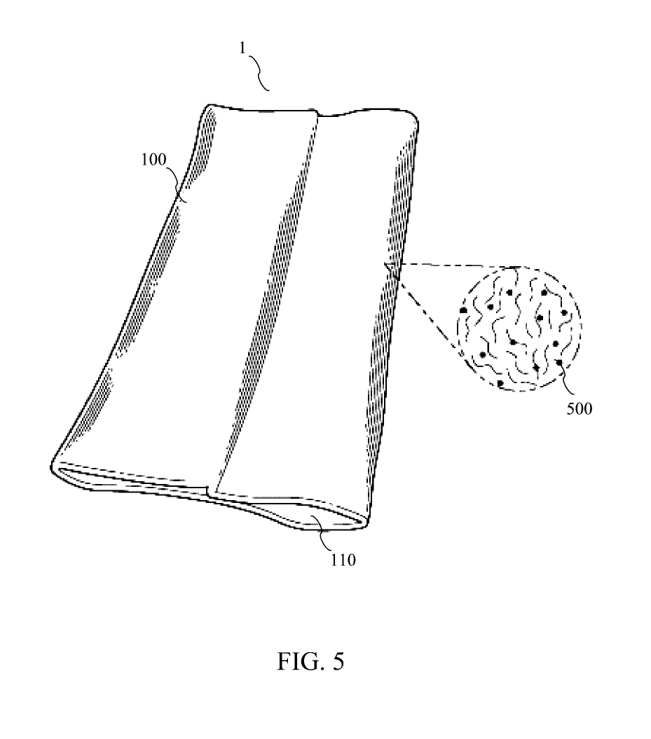

Referring now to FIG. 5, barrier 1 includes an antibacterial substance 500. In some embodiments, antibacterial substance 500 is on exterior surface 100 of barrier 1. In some embodiments, antibacterial substance 500 is on interior surface 110. In some embodiments, antibacterial substance 500 is disposed between exterior surface 100 and interior surface 110.

In some embodiments, antimicrobial substance 500 is selected from the group consisting of: citric acid, silver, and combinations thereof. In some embodiments, antimicrobial substance 500 comprises at least 0.001% by weight silver. In some embodiments, antimicrobial substance 500 comprises at least 4% by weight citric acid. In some embodiments, antimicrobial substance 500 comprises 0.002-0.004% by weight silver. In some embodiments, antimicrobial substance 500 comprises 4% to 5% by weight citric acid.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. An antimicrobial barrier, wearable by an individual, comprising:
an interior surface providing a frictional fit with an individual;
an exterior surface having an antimicrobial substance disposed thereon;
wherein said exterior surface is held substantially stationary relative to an anatomical feature of said individual through said frictional fit.

2. The antimicrobial barrier according to claim 1, wherein said barrier is elastic to provide a radially compressive force.

3. The antimicrobial barrier according to claim 1, wherein said anatomical feature is a joint; and
wherein said barrier is flexible to maintain substantially full range of motion for a joint of said individual.

4. The antimicrobial barrier according to claim 1, wherein said barrier comprises a first end and a second end, said first end releasably attached to said second end to provide said frictional fit when attached.

5. The antimicrobial barrier according to claim 1, wherein said antimicrobial substance is selected from the group consisting of: citric acid, silver, and combinations thereof.

6. The antimicrobial barrier according to claim 1, wherein said antimicrobial substance is disposed on a surface between said exterior surface and said interior surface.

7. The antimicrobial barrier according to claim 1, wherein said antimicrobial substance is disposed on said interior surface.

8. The antimicrobial barrier according to claim 5, wherein said antimicrobial substance comprises at least 0.001% by weight silver.

9. The antimicrobial barrier according to claim 5, wherein said antimicrobial substance comprises at least 4% by weight citric acid.

10. The antimicrobial barrier according to claim 7, wherein said antimicrobial substance comprises 0.002-0.004% by weight silver.

11. The antimicrobial barrier according to claim 9, wherein said antimicrobial substance comprises 4% to 5% by weight citric acid.

12. The antimicrobial barrier according to claim 1, wherein said barrier is a tube shape.

13. The antimicrobial barrier according to claim 12, wherein said barrier is composed of hydrophilic fabric.

14. The antimicrobial barrier according to claim 13, wherein said hydrophilic fabric is non-woven and is sewn to form said tube shape.

15. An antimicrobial barrier, wearable by an individual, comprising:
a cylindrical component having an interior surface and an exterior surface;
an antimicrobial substance disposed on said cylindrical component;
wherein said component is composed of an elastic, non-woven fabric which provides a radially compressive force;
wherein said exterior surface is held in place on an individual by a frictional fit between said interior surface and at least one anatomical feature of said individual selected from the group comprising: a joint, area adjacent to said joint, and combinations thereof;
wherein said frictional fit is provided by said radially compressive force.

16. The antimicrobial barrier according to claim 15, wherein said antimicrobial substance is selected from the group consisting of: citric acid, silver, and combinations thereof.

17. The antimicrobial barrier according to claim 16, wherein said antimicrobial substance comprises 0.002-0.004% by weight silver and 4% to 5% by weight citric acid.

18. The antimicrobial barrier according to claim 15, wherein said component is hydrophilic.

19. The antimicrobial barrier according to claim 15, wherein said component has a first end and a second end, wherein said first end and second end are heat welded to hold said component in said cylindrical conformation.

20. The antimicrobial barrier according to claim 15, wherein said elastic, non-woven fabric is sewn to form to provide said component with said cylindrical conformation.
